(19) United States
(12) Patent Application Publication
(10) Pub. No.: US 2013/0319272 A1
(43) Pub. Date: Dec. 5, 2013

(54) PRINTING METHOD AND PRINTING APPARATUS

(71) Applicant: Sony Corporation, Tokyo (JP)

(72) Inventor: Masanobu Tanaka, Kanagawa (JP)

(73) Assignee: Sony Corporation, Tokyo (JP)

(21) Appl. No.: 13/899,608

(22) Filed: May 22, 2013

(30) Foreign Application Priority Data
Jun. 5, 2012 (JP) 2012-128061

(51) Int. Cl. B41K 1/54

(52) U.S. Cl. CPC B41K 1/54
USPC 101/333

(57) ABSTRACT

A printing method includes: providing an elastic member at a first stage and providing ink between the elastic member and an opposing member, in which the first stage has a protrusion on a surface thereof; and causing contact between the elastic member and the opposing member with the ink interposed therebetween, by using the protrusion.

### BACKGROUND

The technology relates to a printing method using a flat-shaped (sheet-shaped) plate or a flat-shaped (sheet-shaped) blanket, and a printing apparatus using this printing method.

In a printing method such as letterpress printing, intaglio printing, planographic printing, and offset printing, a plate or a blanket is wound around a roll and brought into contact with a printed member on a stage by rotation of the roll. In such a method using the roll, however, it is necessary to use a roll processed with high precision, because the rotation and alignment of the roll are performed to agree with movement of the stage. Besides, it is also necessary to increase resolution of a motor driving the stage, and control the roll and the stage precisely.

Meanwhile, a method of performing printing without using a roll has been also reported. For instance, in Japanese Unexamined Patent Application Publication No. H05-169622, offset printing is performed by fixing an end part of a flat-shaped blanket. In this printing method, it is possible to perform the printing with a simple apparatus because the roll is unused.

### SUMMARY

In such a printing method, in addition to simplicity, achievement of higher positional accuracy is desired.

It is desirable to provide a printing method having high positional accuracy and a printing apparatus using this method.

According to an embodiment of the technology, there is provided a printing method including: providing an elastic member at a first stage and providing ink between the elastic member and an opposing member, the first stage having a protrusion on a surface thereof; and causing contact between the elastic member and the opposing member with the ink interposed therebetween, by using the protrusion.

According to an embodiment of the technology, there is provided a printing apparatus including: a first stage having a protrusion on a surface thereof and supporting an elastic member; a coating section providing ink between the elastic member and an opposing member; and a control section configured to cause, by the protrusion, contact between the elastic member and the opposing member with the ink interposed therebetween.

In the printing method and the printing apparatus according to the above-described embodiments of the technology, the contact between the elastic member and the opposing member is caused by the protrusion of the first stage. Therefore, by moving the first stage and the elastic member relatively to each other in an in-plane direction, transfer of the ink progresses without an outward stretch of the elastic member.

According to the printing method and the printing apparatus in the above-described embodiments of the technology, since the contact between the elastic member and the opposing member is caused by the protrusion of the first stage, the transfer is allowed to proceed without a stretch of the elastic member. Therefore, positional accuracy of printing is allowed to be improved.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to describe the principles of the technology.

FIG. 1 is a diagram illustrating a configuration of a printing apparatus according to an embodiment of the technology.

FIG. 2 is a plan view illustrating a configuration of a movable base depicted in FIG. 1.

FIG. 3A is a cross-sectional diagram illustrating a modification example 1 of a protrusion of the movable base depicted in FIG. 1.

FIG. 3B is a cross-sectional diagram illustrating a modification example 2 of the protrusion of the movable base depicted in FIG. 1.

FIG. 3C is a cross-sectional diagram illustrating a modification example 3 of the protrusion of the movable base depicted in FIG. 1.

FIG. 3D is a cross-sectional diagram illustrating a modification example 4 of the protrusion of the movable base depicted in FIG. 1.

FIG. 4 is a cross-sectional diagram illustrating a modification example 5 of the protrusion of the movable base depicted in FIG. 1.

FIG. 5A is a cross-sectional diagram illustrating a printing process performed by the printing apparatus depicted in FIG. 1.

FIG. 5B is a cross-sectional diagram illustrating a process following FIG. 5A.

FIG. 5C is a cross-sectional diagram illustrating a process following FIG. 5B.

FIG. 6 is a cross-sectional diagram illustrating another example of the process depicted in FIG. 5A.

FIG. 7A is a cross-sectional diagram illustrating a process following FIG. 5C.

FIG. 7B is a cross-sectional diagram illustrating a process following FIG. 7A.

FIG. 7C is a cross-sectional diagram illustrating a process following FIG. 7B.

FIG. 8 is a cross-sectional diagram illustrating a configuration of a printing apparatus according to a comparative example.

FIG. 9A is a cross-sectional diagram illustrating a printing method according to a modification 1.

FIG. 9B is a cross-sectional diagram illustrating a process following FIG. 9A.

FIG. 9C is a cross-sectional diagram illustrating a process following FIG. 9B.

FIG. 10A is a cross-sectional diagram illustrating a process following FIG. 9C.

FIG. 10B is a cross-sectional diagram illustrating a process following FIG. 10A.

FIG. 10C is a cross-sectional diagram illustrating a process following FIG. 10B.

FIG. 11A is a cross-sectional diagram illustrating a printing method according to a modification 2.

FIG. 11B is a cross-sectional diagram illustrating a process following FIG. 11A.

FIG. 11C is a cross-sectional diagram illustrating a process following FIG. 11B.

FIG. 12 is a cross-sectional diagram illustrating a configuration of a display unit manufactured using the printing apparatus depicted in FIG. 1.

FIG. 13 is a diagram illustrating an overall configuration of the display unit depicted in FIG. 12.

FIG. 14 is a circuit diagram illustrating an example of a pixel driving circuit depicted in FIG. 13.

FIG. 15 is a perspective diagram illustrating an appearance of an application example 1.

FIG. 16A is a perspective diagram illustrating an appearance of an application example 2 when viewed from front.

FIG. 16B is a perspective diagram illustrating an appearance of the application example 2 when viewed from back.

FIG. 17 is a perspective diagram illustrating an appearance of an application example 3.

FIG. 18 is a perspective diagram illustrating an appearance of an application example 4.

FIG. 19A is a diagram illustrating a closed state of an application example 5.

FIG. 19B is a diagram illustrating an open state of the application example 5.

### DETAILED DESCRIPTION

An embodiment of the technology will be described in detail with reference to the drawings. It is to be noted that the description will be provided in the following order.

1. Embodiment (a printing apparatus having a protrusion at a first stage: an example of gravure offset printing)
2. Modification 1 (an example of reverse offset printing)
3. Modification 2 (an example of letterpress printing)
4. Application examples (display units)

### Embodiment

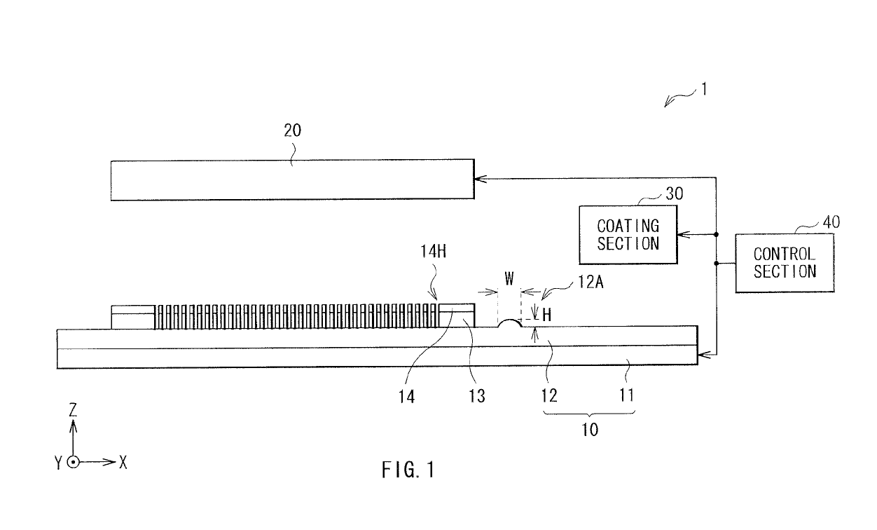

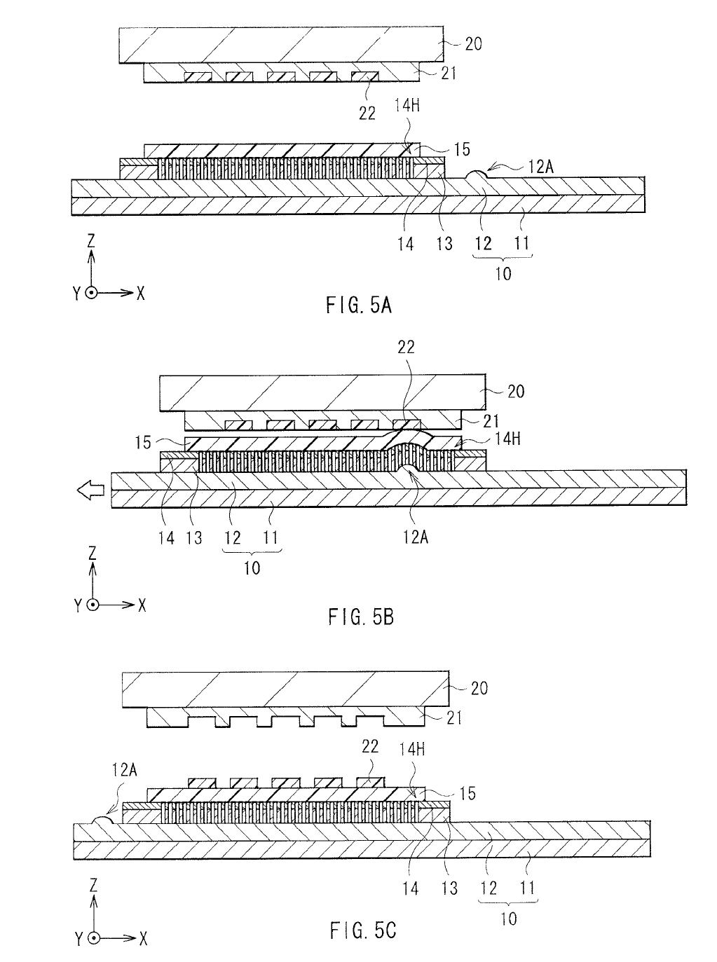

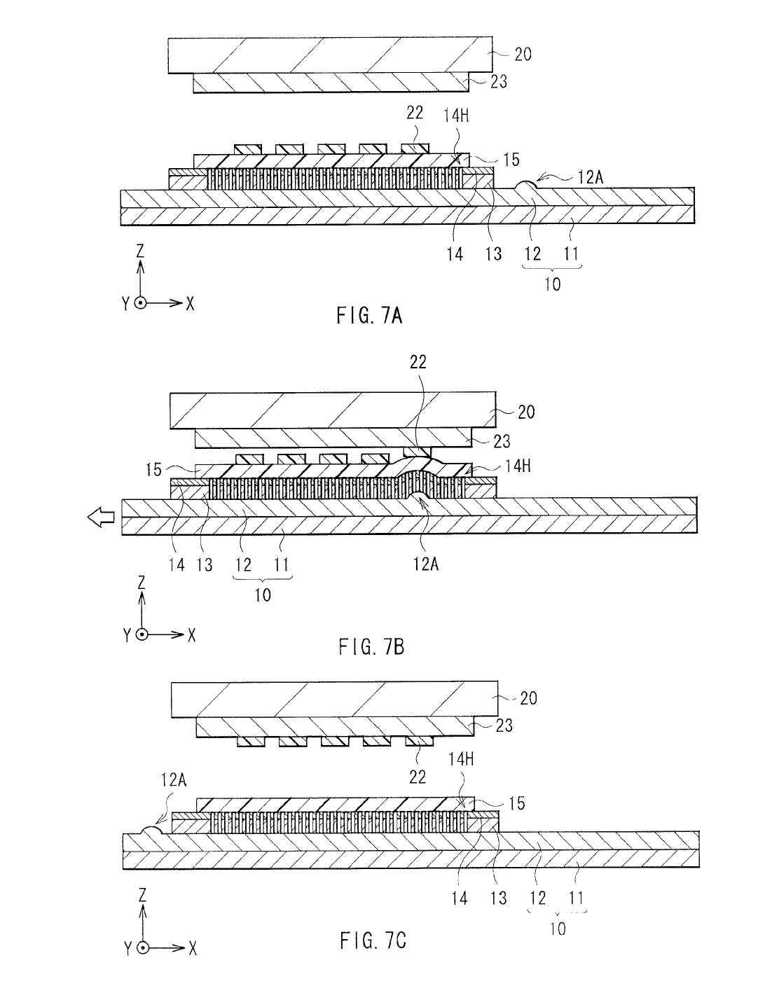

FIG. 1 schematically illustrates a configuration of a printing apparatus (a printing apparatus 1) according to an embodiment of the technology. The printing apparatus 1 includes a first stage 10, a second stage 20 facing the first stage 10, a coating section 30, and a control section 40. In this printing apparatus 1, a flat-shaped elastic member (a blanket 15 in FIG. 5A, which will be described later) and an opposing member (an intaglio plate 21 in FIG. 5A or a substrate 23 in FIG. 7A, both will be described later) are provided in the first stage 10 and the second stage 20, respectively, so that printing is performed. Ink (ink 22 in FIG. 5A, which will be described later) is applied between the elastic member and the opposing member, i.e., to a surface (or a counter surface) of either of these members, by the coating section 30. The printing is performed by causing contact between the opposing member and the elastic member with the ink interposed therebetween. The control section 40 transmits signals to the first stage 10, the second stage 20, and the coating section 30, thereby controlling operation of these elements.

The first stage 10 has a base driving section 11 and a movable base 12 on the base driving section 11. The movable base 12 is provided with a protrusion 12A which may be, for example, an arc-shaped protrusion protruding from a surface of the movable base 12. The base driving section 11 may include, for example, a driving source such as a motor, and the movable base 12 is allowed to move in an in-plane direction by this base driving section 11. In other words, the protrusion 12A moves in the in-plane direction of the movable base 12 as well. In the present embodiment, the elastic member is pushed up by this protrusion 12A locally, which causes the contact between the elastic member and the opposing member, thereby performing transfer of the ink. As will be described later in detail, this makes it possible to perform printing with high positional accuracy. As the driving source of the base driving section 11, for example, a linear motor or the like may be used. The movable base 12 may be configured using, for example, aluminum (Al) which may have a thickness (in a Z direction) of about 10 mm to about 500 mm.

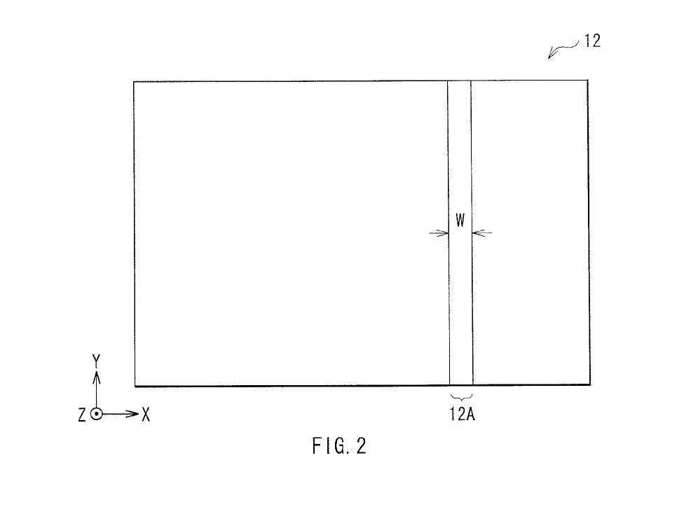

As illustrated in FIG. 2, the protrusion 12A extends like a ridge, in a direction intersecting a moving direction of the movable base 12. For instance, the protrusion 12A may extend in a Y direction, and the movable base 12 may move in an X direction intersecting the Y direction at right angles.

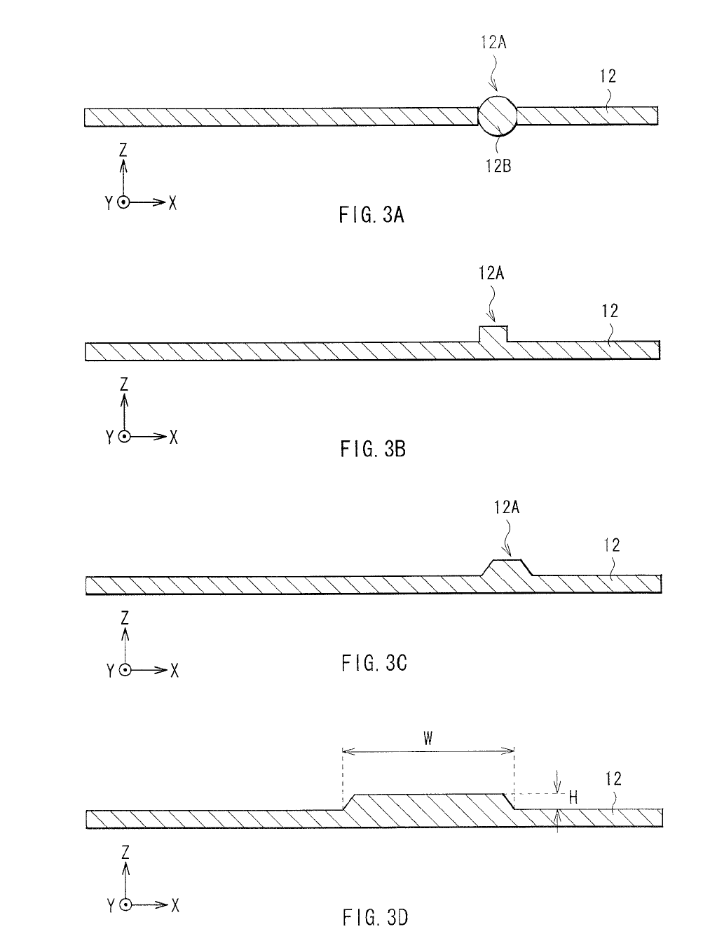

The protrusion 12A may be configured of a roll 12B as illustrated in FIG. 3A. This roll 12B performs parallel movement in the X direction while rotating. Alternatively, the protrusion 12A may be an angular protrusion that protrudes from the surface of the movable base 12, and a cross section (an XZ section) of this protrusion 12A may be in the shape of, for example, a rectangle (FIG. 3B), a square (not illustrated), or a trapezoid (FIG. 3C). Further, it is possible to increase a width W (in the X direction) of the protrusion 12A as illustrated in FIG. 3D. The length of contact time between the elastic member and the opposing member (i.e. printing pressure time) is adjustable by using the size of this width W. Furthermore, the magnitude of pressure in causing the contact between the opposing member and the elastic member is also adjustable by using a height H (in the Z direction) of the protrusion 12A. The height H of the protrusion 12A may be, for example, about 20 μm to about 1000 μm, and the width W may be, for example, about 1 cm to about 500 cm.

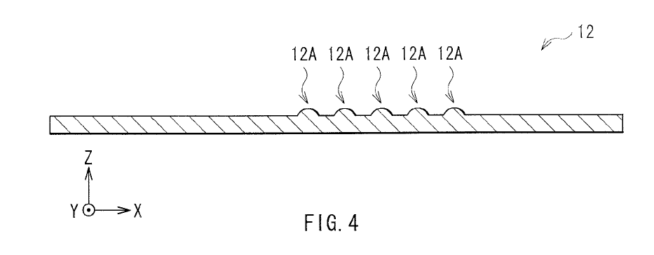

In addition, the movable base 12 may be provided with a plurality of protrusions 12A as illustrated in FIG. 4. It is possible to reduce printing time by increasing the number of the protrusions 12A.

A part on the movable base 12 of the first stage 10 is provided with a supporting base 14 (a supporting member) (FIG. 1). While the movable base 12 is configured to move, the supporting base 14 may be connected to, for example, a frame (not illustrated) of the printing apparatus 1 and fixed to a predetermined location in the printing apparatus 1. The supporting base 14 supports the elastic member, and the position of the elastic member relative to the opposing member is fixed by this supporting base 14. A plurality of adsorption apertures 14H used to fix the position of the elastic member may be provided in a central part of the supporting base 14, for example. The elastic member is attached to the supporting base 14 through vacuum adsorption by these adsorption apertures 14H, so that the position thereof is fixed. Instead of the adsorption apertures 14H, an O ring (not illustrated) or the like may be provided in the circumference of the supporting base 14 to fix the elastic member. The elastic member may be fixed using both of the adsorption apertures 14H and the O ring. The supporting base 14 may be configured using, for example, a plate-shaped member which may be made of SUS and which may have a thickness (in the Z direction) of about 0.05 mm to about 0.5 mm.

A surface of the supporting base 14, the surface facing the movable base 12, i.e. between the supporting base 14 and the movable base 12, is provided with a low friction layer 13. The low friction layer 13 reduces a frictional force (friction resistance) which is caused between the movable base 12 and the supporting base 14 by the movement of the movable base 12. Misalignment of the supporting base 14 is allowed to be prevented by the movement of the movable base 12 which moves while being in contact with this low friction layer 13. The low friction layer 13 may be configured using, for example, resin with low surface energy, such as fluororesin. The adsorption apertures 14H also pass through the low friction layer 13, and the elastic member, the supporting base 14, and the movable base 12 are closely attached to one another by vacuum adsorption. Instead of using the low friction layer 13, the frictional resistance may be reduced by applying a roughening treatment to the surface of the supporting base 14, the surface facing the movable base 12. The roughening treatment may be performed, for example, through machining, sandblast, plating, or the like. The friction resistance may also be suppressed by placing a columnar fiber between the movable base 12 and the supporting base 14. The low friction layer 13 may be provided on the surface of the movable base 12, the surface facing the supporting base 14 (not illustrated), or may be provided on both of the supporting base 14 and the movable base 12. Further, the roughening treatment may be applied to the surface of the movable base 12, or to both of the surface of the supporting base 14 and the surface of the movable base 12.

The second stage 20 is provided with the opposing member on the surface thereof facing the first stage 10, and supports this opposing member. The opposing member may be fixed to the second stage 20 by, for example, vacuum adsorption, electrostatic adsorption, clamping, or the like.

The ink is applied to the surface of either the elastic member or the opposing member by the coating section 30. For instance, the coating section 30 may have a squeegee (not illustrated), and may apply the ink by squeegee coating. In the coating section 30, other than the squeegee coating, for example, a microgravure method, a doctor blade method, spin coating, slit coating, a spraying method, a CAP coating method, a LB (Langmuir-Blodgett) film-formation method, an ink-jet method, or the like may be used.

After driving the coating section 30, the control section 40 brings the first stage 10 (the supporting base 14) and the second stage 20 closer to each other, and controls transfer of the ink between the elastic member and the opposing member. This transfer may be performed as follows. For instance, after the second stage 20 is lowered and thereby the distance between the elastic member and the opposing member is reduced to a level equal to or below the height H of the protrusion 12A, the movable base 12 is moved in the in-plane direction (for example, in a leftward direction on a sheet surface of FIG. 1). This movement of the movable base 12 causes the protrusion 12A to enter below the elastic member, which locally pushes up the elastic member sequentially. This causes the contact between the opposing member and the elastic member with the ink interposed therebetween, so that the transfer of the ink is achieved.

Gravure offset printing using the above-described printing apparatus 1 may be performed as follows, for example (from FIG. 5A to FIG. 7C).

First, the intaglio plate 21 is placed on a plate bed (not illustrated), and a depression section of the intaglio plate 21 is filled with the ink 22 by the squeegee of the coating section 30. The intaglio plate 21 may be, for example, a plate-shaped member which may be made of quartz, glass, resin, or metal, and in which the depression section having a predetermined pattern is formed by photolithography, etching, or the like. The ink 22 may be, for instance, resist ink for offset, and contains a solvent and a solute. The solute of the ink 22 may be selected as appropriate depending on a printed material. Examples of the solute may include metal powder, glass powder, resin, pigment, dye, powder made of a semiconductor such as silicon, an organic conductive material, an organic insulating material, an organic semiconductor material, an organic luminescent material, or metal microparticles (metal nanoparticles), or a mixture of any combination of these materials. The solute disperses or dissolves the above-described solvent. Usable examples of the solute may include linear alkanes such as pentane, hexane, and heptane, cycloalkanes such as cyclopentane and cyclohexane, ethers such as ethyl methyl ether, diethyl ether, and tetrahydrofuran.

Next, this intaglio plate 21 is fixed to the second stage 20 so that the surface on which the ink 22 is provided faces the first stage 10 (the supporting base 14). The intaglio plate 21 may be filled with the ink 22 on the second stage 20. Of the intaglio plate 21, for instance, a central part and the circumference thereof may be fixed to the second stage 20 by vacuum adsorption and clamping, respectively. On the other hand, the blanket 15 is fixed to the supporting base 14 on the first stage 10 (FIG. 5A). The blanket 15 may include, for example, a PDMS (polydimethylsiloxane) layer which may have a thickness of about 1 μm to about 5000 μm, on a hard base material. The hard base material may be made of a glass plate, a metal plate, or the like, and may have a thickness of about 10 μm to about 500 μm. The blanket 15 has elasticity. The ink 22 may be applied to contact this PDMS layer. For example, STD-700 (available from Fujikura Rubber Ltd., located in Tokyo, Japan) may be used for the blanket 15.

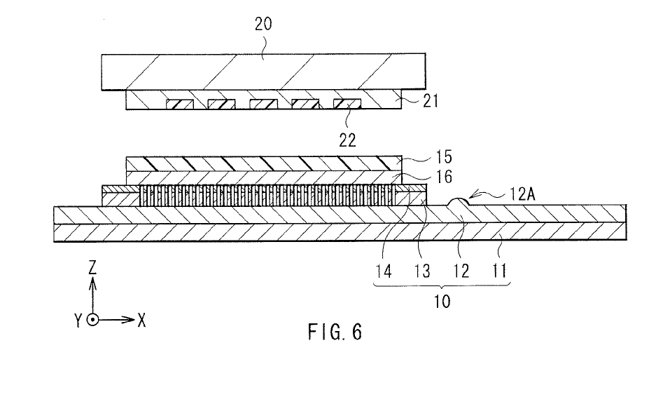

A buffering member 16 may be provided between the blanket 15 and the supporting base 14 as illustrated in FIG. 6. The buffering member 16 is provided to equalize in-plane pressure exerted when the contact between the blanket 15 and the intaglio plate 21 is caused by the protrusion 12A (i.e. pressure at the time of printing). The buffering member 16 may have, for example, the same planar shape as a planar shape of the blanket 15. The magnitude of the pressure at the time of printing depends on the thickness of the supporting base 14, the thickness of the intaglio plate 21 (or the substrate 23 which will be described later), parallelism between the first stage 10 and the second stage 20, and the like, in addition to the height H of the protrusion 12A. In the supporting base 14 and/or the intaglio plate 21, for instance, minute thickness variations may occur within a plane, and this might cause unevenness of pressure. Although this unevenness of pressure at the time of printing is reduced also by the elasticity of the blanket 15, providing the buffering member 16 makes it possible to maintain the pressure in the printing uniform within the plane with more reliability. Therefore, it is possible to transfer the shape of the pattern of the ink 22 precisely. In addition, providing the buffering member 16 allows, for example, a wider range of unevenness in the thickness of the intaglio plate 21 and thus, it is possible to perform processing of the intaglio plate 21 easily. Polyurethane which may have a thickness of about 0.5 mm to about 5 mm, for instance, may be used for the buffering member 16.

After the blanket 15 and the intaglio plate 21 filled with the ink 22 are provided on the first stage 10 side and the second stage 20 side, respectively, the distance between the intaglio plate 21 and the blanket 15 may be reduced to the level equal to or below the height H of the protrusion 12A by, for example, lowering the second stage 20. The intaglio plate 21 and the blanket 15 may be brought closer to each other, so that, for instance, the protrusion 12A is pushed into the intaglio plate 21 by about 200 μm. Next, the base driving section 11 moves the movable base 12 in the X direction (in a direction indicated by an arrow in FIG. 5B) as illustrated in FIG. 5B. This causes the protrusion 12A to enter below the blanket 15, and the blanket 15 comes into contact with the intaglio plate 21 while being sequentially pushed up from one end (a right side parallel with a Y axis in FIG. 5B) to the other end (a left side parallel with the Y axis in FIG. 5B) thereof. In this process, the entire surface of the blanket 15 may be fixed to the supporting base 14 through, for example, vacuum adsorption by the adsorption apertures 14H, allowing it to prevent a situation where only an end part thereof is fixed. After the passage of the protrusion 12A, the blanket 15 is separated from the intaglio plate 21, and thereby the ink 22 is transferred from the intaglio plate 21 to the blanket 15 (FIG. 5C). As a result, the ink 22 having a predetermined pattern (corresponding to the depression section of the intaglio plate 21) is provided on the blanket 15.

After the ink 22 from the intaglio plate 21 is received by the blanket 15, the ink 22 is transferred from the blanket 15 to a printed member (the substrate 23) in a similar manner. The substrate 23 may be selected as appropriate according to the ink 22 (a printed material), which may be, for example, silicon, synthetic quarts, glass, metal, resin, a resin film, or the like. The transfer of the ink 22 from the blanket 15 to the substrate 23 may be performed as follows. First, the intaglio plate 21 fixed to the second stage 20 is replaced with the substrate 23 (FIG. 7A). Subsequently, contact between the blanket 15 and the substrate 23 with the ink 22 interposed therebetween is caused by the protrusion 12A (FIG. 7B). As a result, the ink 22 from the blanket 15 is received by the substrate 23 (FIG. 7C). In the printing apparatus 1, the gravure offset printing may be thus performed onto the substrate 23.

As described above, in the printing apparatus 1, the movable base 12 is provided with the protrusion 12A, and the printing is performed by moving the movable base 12 in the in-plane direction. This makes it possible to perform the printing with high positional accuracy. This will be described below.

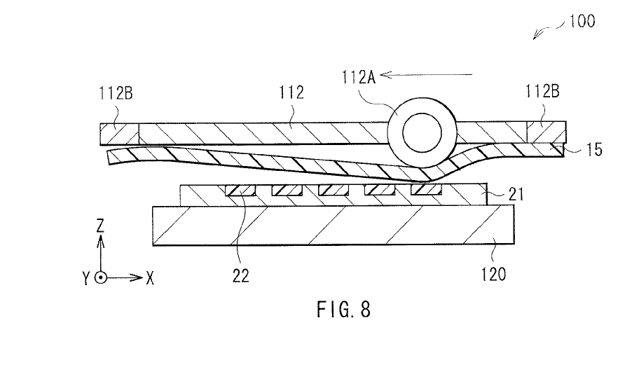

FIG. 8 illustrates a configuration of a printing apparatus (a printing apparatus 100) according to a comparative example. This printing apparatus 100 has a carrier 112 having a roller 112A, and a second stage 120 facing the carrier 112. A blanket 15 and an intaglio plate 21 (or a substrate 23 (not illustrated)) are supported by the carrier 112 and the second stage 120, respectively. The blanket 15 is attached to an elastic porous metal sheet (not illustrated), and only both ends of these are supported by fixing sections 112B of the carrier 112. While both ends of this blanket 15 are stretched outward together with the porous metal sheet, these are partially deformed by the roller 112A to come into contact with the intaglio plate 21. The roller 112A moves in a direction indicated by an arrow, so that the blanket 15, sequentially from one end to the other end thereof, comes in contact with the intaglio plate 21. Transfer of the ink 22 is thus performed in the printing apparatus 100. In the printing apparatus 100 described above, since the blanket 15 is brought into contact with the intaglio plate 21 while being stretched, the position of a pattern of the ink 22 is misaligned, which reduces positional accuracy in printing.

In the printing apparatus 1, in contrast, the movable base 12 is provided with the protrusion 12A used to cause the contact between the blanket 15 and the intaglio plate 21, and the printing is performed by moving this movable base 12 in the in-plane direction. In this process, the movable base 12 may be moved in a state in which the entire blanket 15 is fixed to the supporting base 14 by, for example, vacuum adsorption. Therefore, when a part of the blanket 15 is pushed up by the protrusion 12A, both ends of the blanket 15 are drawn to the central part, accordingly. Thus, the blanket 15 is not stretched outward and therefore, printing with high positional accuracy is allowed to be performed.

As described above, in the present embodiment, since the protrusion 12A is provided at the movable base 12, the ink 22 is transferrable by causing the blanket 15 and the movable base 12 to move relatively to each other. Therefore, an end of the blanket 15 is not stretched outward and thus, it is possible to perform the printing with high positional accuracy.

Further, the contact time between the blanket 15 and the intaglio plate 21 (or the substrate 23) is adjustable by the width W of the protrusion 12A, and the pressure at the time of printing is adjustable by the height H of the protrusion 12A. Furthermore, the printing time is allowed to be reduced by providing the plurality of protrusions 12A at the movable base 12.

In addition, the low friction layer 13 may be provided between the movable base 12 and the supporting base 14 to prevent misalignment of the supporting base 14.

Moreover, the buffering member 16 may be provided between the blanket 15 and the supporting base 14 to maintain the pressure in the printing uniform in the plane.

### [Modification 1]

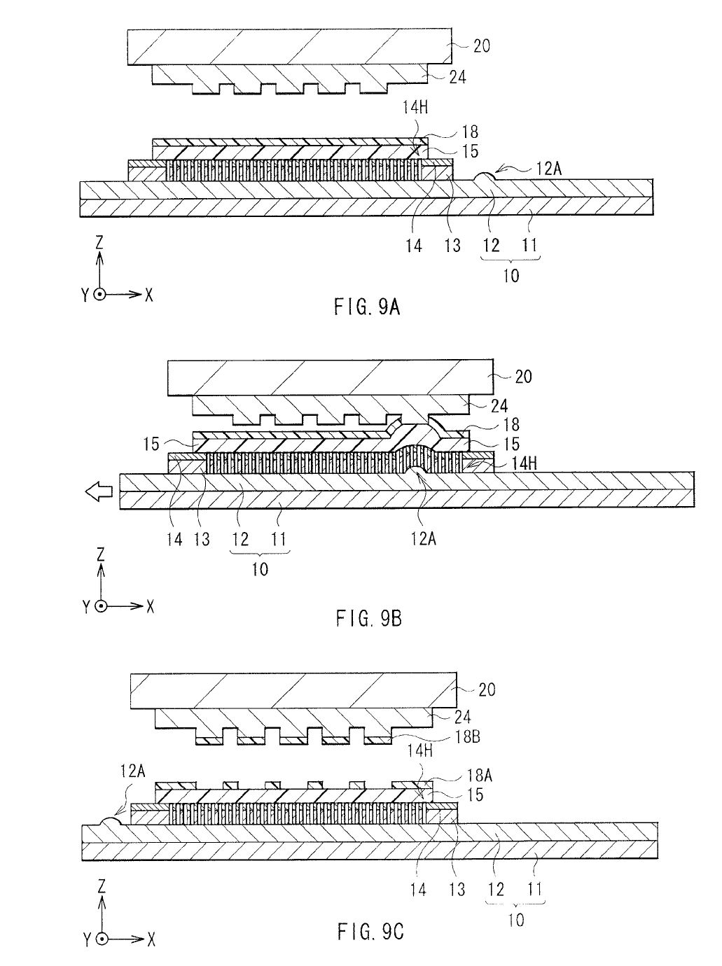

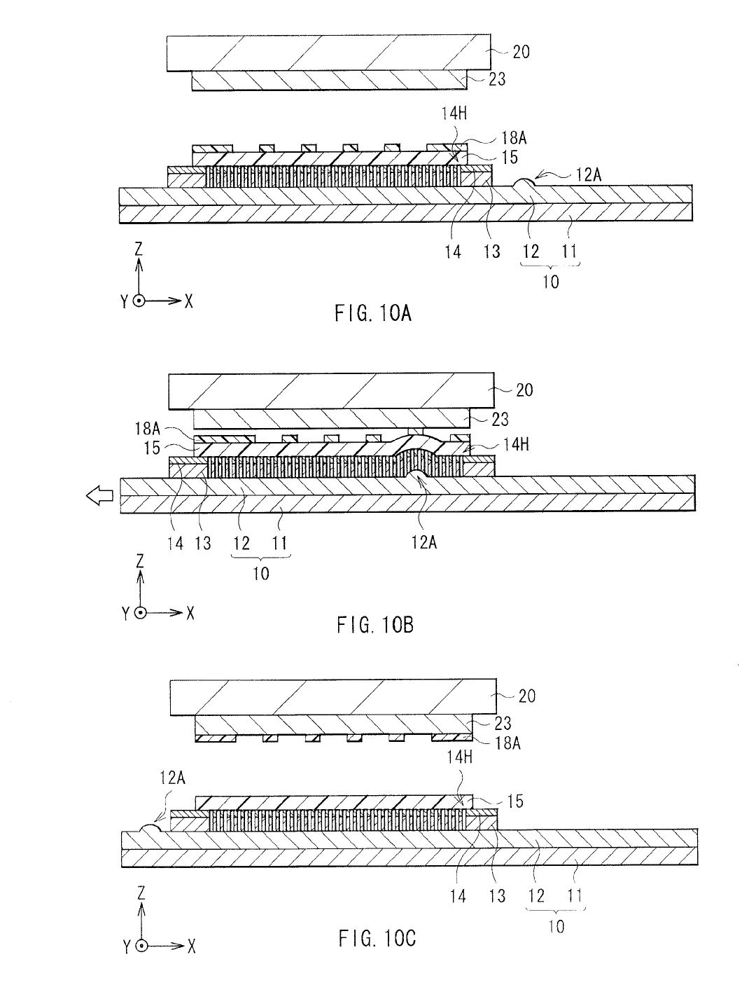

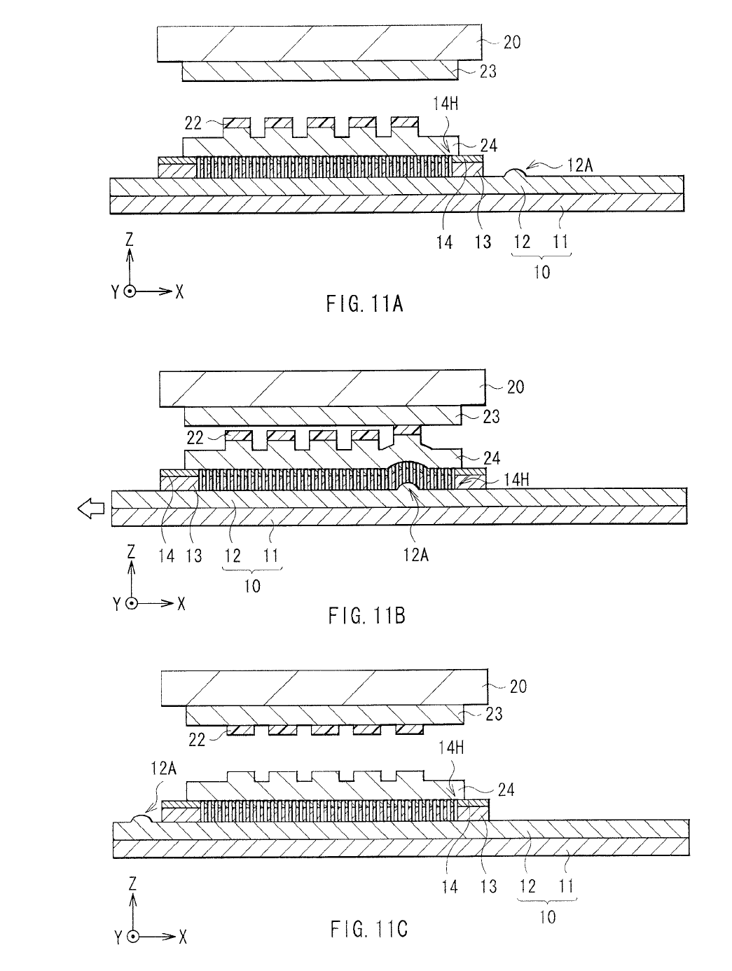

Reverse offset printing may be performed using the printing apparatus 1 of the above-described embodiment (FIG. 9A to FIG. 10C).

First, the blanket 15 is fixed onto the supporting base 14 and then, ink 18 may be applied to the entire surface of the blanket 15 by the coating section 30, for example. On the other hand, a relief plate 24 is fixed to the second stage 20, so that a projection section on a surface of the relief plate 24 faces the first stage 10 (FIG. 9A).

Next, the distance between the relief plate 24 and the blanket 15 may be reduced to a level equal to or below the height H of the protrusion 12A by lowering the second stage 20, for example, following which the base driving section 11 moves the movable base 12 in an X direction (in a direction indicated by an arrow in FIG. 9B) as illustrated in FIG. 9B. This causes the protrusion 12A to enter below the blanket 15, and the blanket 15 comes into contact with the relief plate 24 while being sequentially pushed up from one end to the other end thereof. Following the passage of the protrusion 12A, the blanket 15 is separated from the relief plate 24, so that a pattern (ink 18A) of the ink 18 is formed on the blanket 15 (FIG. 9C). This ink 18A is formed by a selective removal of the ink 18B that has made contact with the projection section of the relief plate 24, of the ink 18 applied to the blanket 15.

After the ink 18A is provided on the blanket 15, the ink 18A is transferred from the blanket 15 to the substrate 23, in a manner similar to that in the gravure offset printing described above. Specifically, after the relief plate 24 fixed to the second stage 20 is replaced with the substrate 23 (FIG. 10A), contact between the blanket 15 and the substrate 23 with the ink 18A interposed therebetween is caused by the protrusion 12A (FIG. 10B), so that the ink 18A is transferred to the substrate 23 (FIG. 10C). In the printing apparatus 1, the reverse offset printing on the substrate 23 may be thus performed.

### [Modification 2]

Further, letterpress printing may be performed using the printing apparatus 1 of the above-described embodiment (FIG. 11A to FIG. 11C).

First, a relief plate 24 (a plate) which may be made of, for example, an elastic material such as silicone rubber, urethane rubber, and acrylonitrile is fixed onto the supporting base 14, and then, the ink 22 is provided at a projection section of the relief plate 24 by the coating section 30. To the second stage 20, on the other hand, the substrate 23 is fixed to face the relief plate 24 (FIG. 11A).

Next, the distance between the substrate 23 and the relief plate 24 may be reduced to the level equal to or below the height H of the protrusion 12A by lowering the second stage 20, for example, following which the base driving section 11 moves the movable base 12 in an X direction (a direction indicated by an arrow in FIG. 11B) as illustrated in FIG. 11B. This causes the protrusion 12A to enter below the relief plate 24, and the relief plate 24 comes into contact with the substrate 23 while being sequentially pushed up from one end to the other end thereof. Following the passage of the protrusion 12A, the relief plate 24 is separated from the substrate 23, so that the ink 22 of the projection section is transferred to the substrate 23 (FIG. 11C). In the printing apparatus 1, the letterpress printing on the substrate 23 may be thus performed.

### APPLICATION EXAMPLES

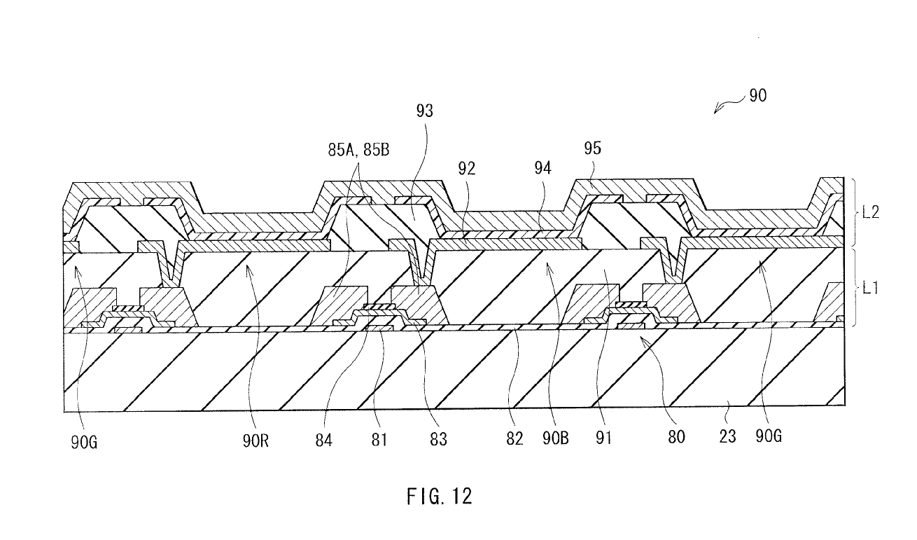

A part of a display unit (a display unit 90) illustrated in FIG. 12, for example, may be manufactured using the printing apparatus 1 of the above-described embodiment. This display unit 90 may be a self-luminous-type display unit having a plurality of organic light-emitting devices 90R, 90G, and 90B. The display unit 90 has a pixel-driving-circuit formed layer L1, a light-emission-device formed layer L2, and a counter substrate (not illustrated) in this order on the substrate 23. The light-emission-device formed layer L2 includes the organic light-emitting devices 90R, 90G, and 90B.

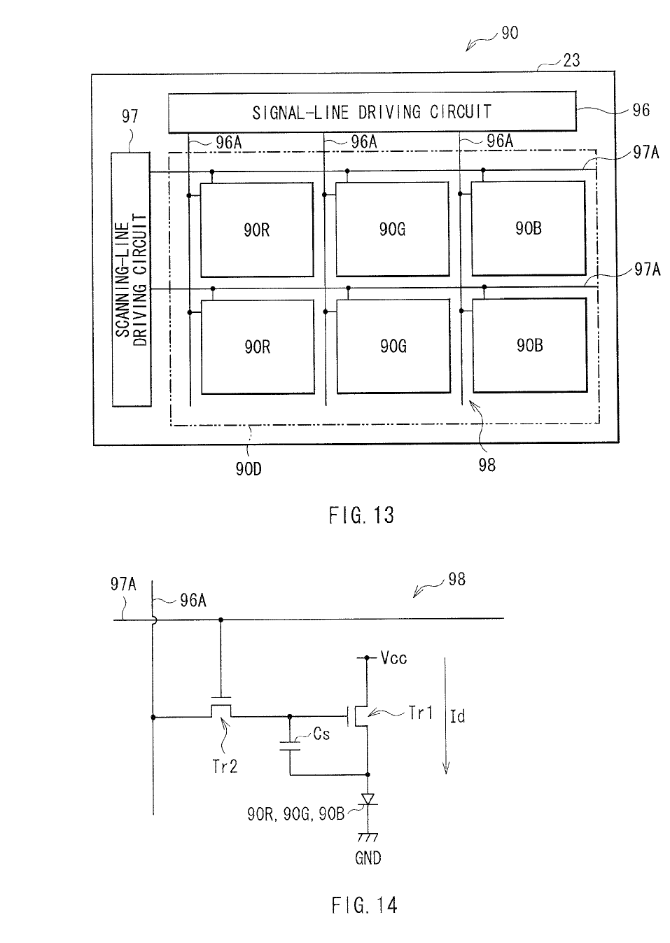

FIG. 13 illustrates an overall configuration of the display unit 90. The display unit 90 has a display region 90D on the substrate 23, and is used as an ultrathin organic light-emitting color display device. Around the display region 90D on the substrate 23, for example, a signal-line driving circuit 96 and a scanning-line driving circuit 97 which are drivers for image display may be provided.

In the display region 90D, the plurality of organic light-emitting devices 90R, 90G, and 90B arranged two-dimensionally in a matrix and a pixel driving circuit 98 used to drive these devices are formed. In the pixel driving circuit 98, a plurality of signal lines 96A are arranged in a column direction, and a plurality of scanning lines 97A are arranged in a row direction. Each of the organic light-emitting devices 90R, 90G, and 90B is provided to correspond to an intersection between each of the signal lines 96A and each of the scanning lines 97A. Each of the signal lines 96A and each of the scanning lines 97A are connected to the signal-line driving circuit 96 and the scanning-line driving circuit 97, respectively.

The signal-line driving circuit 96 supplies each of the organic light-emitting devices 90R, 90G, and 90B selected through the signal line 96A with a signal voltage of an image signal corresponding to luminance information supplied from a signal supply source (not illustrated). The signal voltage is applied from the signal-line driving circuit 96 to the signal line 96A.

The scanning-line driving circuit 97 includes a shift register etc. which sequentially perform shifting (transfer) of a start pulse in synchronization with an inputted clock pulse. When writing an image signal to the organic light-emitting devices 90R, 90G, and 90B, the scanning-line driving circuit 97 scans these devices row by row, and sequentially supplies a scanning signal to each of the scanning lines 97A. The scanning signal is supplied from the scanning-line driving circuit 97 to the scanning line 97A.

The pixel driving circuit 98 is provided in a layer between the substrate 23 and the organic light-emitting devices 90R, 90G, and 90B, namely, the pixel-driving-circuit formed layer L1. This pixel driving circuit 98 may be an active drive circuit having a drive transistor Tr1, a write transistor Tr2, a retention capacitor Cs therebetween, and the organic light-emitting devices 90R, 90G, and 90B as illustrated in FIG. 14.

Next, a detailed configuration including elements such as the pixel-driving-circuit formed layer L1 and the light-emission-device formed layer L2 will be described with reference to FIG. 12.

A transistor 80 (the drive transistor Tr1 and the write transistor Tr2) of the pixel driving circuit 98 is formed in the pixel-driving-circuit formed layer L1, and further, the signal lines 96A and the scanning lines 97A are also embedded therein. Specifically, the transistor 80 and a flattening layer 91 are provided in this order on the substrate 23. The transistor 80 may be, for example, a bottom-gate-type transistor having a gate electrode 81, a gate insulating film 82, and a semiconductor film 83 in this order from the substrate 23 side. Source-drain electrodes 85A and 85B are electrically connected to the semiconductor film 83. A channel region of the semiconductor film 83 is covered with a channel protective film 84, and the flattening layer 91 is provided on this channel protective film 84 as well as the source-drain electrodes 85A and 85B. The flattening layer 91 is provided to flatten mainly a surface of the pixel-driving-circuit formed layer L1, and may be formed of, for example, an insulating resin material such as polyimide.

The light-emission-device formed layer L2 is provided with the organic light-emitting devices 90R, 90G, and 90B, a device separating film 93, and a sealing layer (not illustrated) used to cover them. In each of the organic light-emitting devices 90R, 90G, and 90B, a first electrode 92 serving as an anode electrode, an organic layer 94 including a luminous layer, and a second electrode 95 serving as a cathode electrode are laminated in this order from the substrate 23 side. The organic layer 94 may have, for example, a hole injection layer, a hole transport layer, the luminous layer, and an electron transport layer in this order from the first electrode 92 side. This luminous layer may be provided for each device (FIG. 14) or provided as a common to each device (not illustrated). Here, this luminous layer of the organic layer 64 may be manufactured using the printing apparatus 1. Layers other than the luminous layer may be provided as necessary. The device separating film 93 is made of an insulating material, and provided to separate the organic light-emitting devices 90R, 90G, and 90B from each other and define a light emission region of each of the organic light-emitting devices 90R, 90G, and 90B. The organic light-emitting devices 90R, 90G, and 90B are covered with a protective layer (not illustrated), and the counter substrate (not illustrated) is provided on this protective layer with an adhesive layer (not illustrated) interposed therebetween. The counter substrate may have, for example, a color filter corresponding to the organic light-emitting devices 90R, 90G, and 90B.

This display unit 90 may be manufactured as follows, for example.

First, the pixel driving circuit 98 including the transistor 80 and the flattening layer 91 are formed on the substrate 23 which may be made of glass. The pixel-driving-circuit formed layer L1 is thereby formed.

Next, a titanium film and an aluminum alloy film may be formed by, for example, sputtering, which may be then molded into a predetermined shape by, for example, a photolithographic method and dry etching, so that the first electrode 92 is formed. Subsequently, a photosensitive insulating material such as polyimide is applied onto the flattening layer 91 and the first electrode 92, and then exposure and development by photolithography are performed, so that the device separating film 93 is formed.

After the device separating film 93 is formed, the luminous layer of the organic layer 94 may be formed using the printing apparatus 1 of the above-described embodiment. The hole injection layer, the hole transport layer, and the electron transport layer of the organic layer 94 may be formed using the printing apparatus 1, or may be formed using a method such as vapor deposition. Next, the second electrode 95 may be formed on the organic layer 94 by vapor deposition, for example. The light-emission-device formed layer L2 is thereby formed.

A protective film (not illustrated) may be formed on the organic light-emitting devices (organic EL devices) 90R, 90G, and 90B as necessary by, for example, CVD (Chemical Vapor Deposition) or sputtering. Further, the counter substrate (not illustrated) on which the color filter etc. is formed is prepared, and this counter substrate is adhered to the protective film by using the adhesive layer (not illustrated). This completes the display unit 90 illustrated in FIG. 12 to FIG. 14.

The display unit 90 as described above is applicable to display units of electronic apparatus in all fields, which display externally-inputted image signals or internally-generated image signals as still or moving images. The electronic units may include, for example, television receivers, digital cameras, laptop computers, portable terminals such as portable telephones, video cameras, and the like.

### Application Example 1

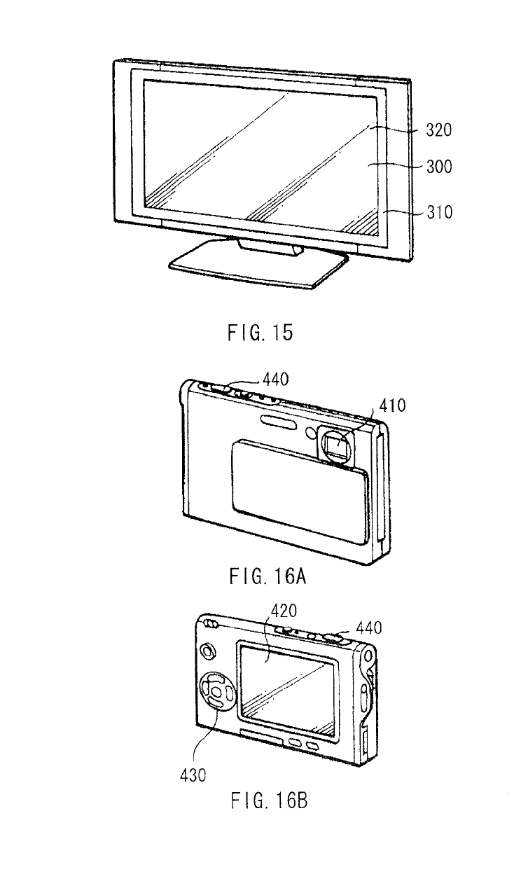

FIG. 15 illustrates an appearance of a television receiver. This television receiver may have, for example, an image-display screen section 300 that includes a front panel 310 and a filter glass 320. The image-display screen section 300 is configured using the display unit 90.

### Application Example 2

FIGS. 16A and 16B each illustrate an appearance of a digital camera. This digital camera may include, for example, a flash emitting section 410, a display section 420, a menu switch 430, and a shutter release 440. The display section 420 is configured using the display unit 90.

### Application Example 3

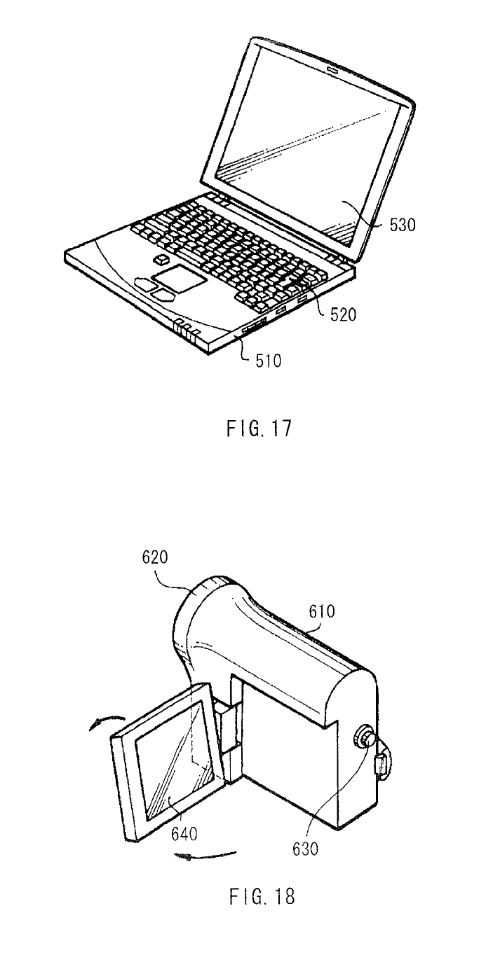

FIG. 17 illustrates an appearance of a laptop computer. This laptop computer may include, for example, a main body section 510, a keyboard 520 provided to enter characters and the like, and a display section 530 displaying an image. The display section 530 is configured using the display unit 90.

### Application Example 4

FIG. 18 illustrates an appearance of a video camera. This video camera may include, for example, a main body section 610, a lens 620 disposed on a front face of this main body section 610 to shoot an image of a subject, a start/stop switch 630 used in shooting, and a display section 640. The display section 640 is configured using the display unit 90.

### Application Example 5

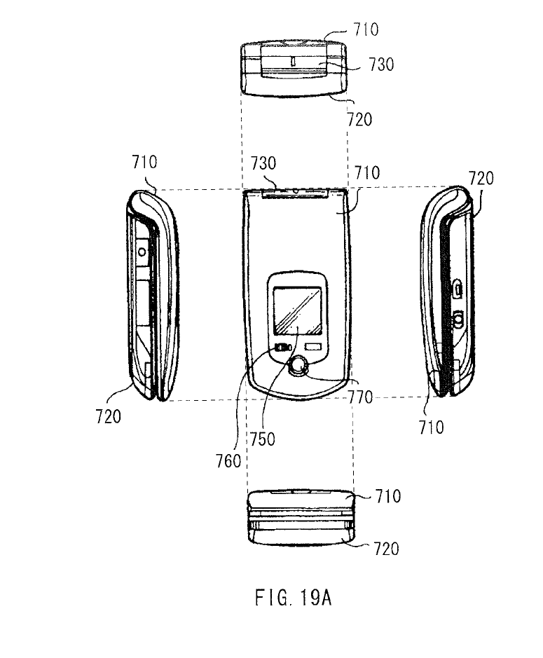

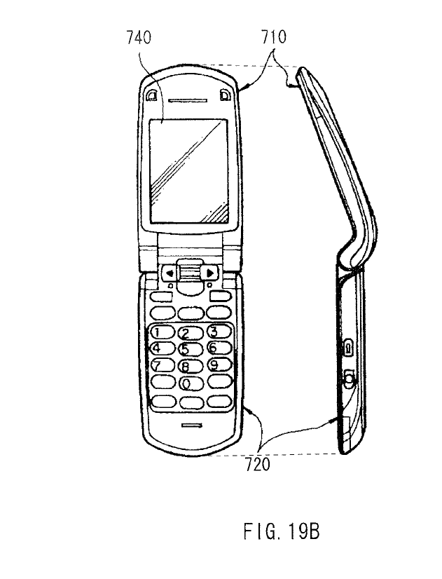

FIGS. 19A and 19B each illustrate appearances of a portable telephone. This portable telephone may be, for example, a unit in which an upper housing 710 and a lower housing 720 are connected by a coupling section (a hinge section) 730, and may include a display 740, a sub-display 750, a picture light 760, and a camera 770. The display 740 or the sub-display 750 is configured using the display unit 90.

The technology has been described with reference to the example embodiment and the modifications, but is not limited thereto and may be variously modified. For example, in the above-described embodiment and the like, the case in which the movable base 12 is moved in the in-plane direction has been described. However, the second stage 20, the opposing member (such as the intaglio plate 21, the relief plate 24, and the substrate 23) supported by the second stage 20, and the elastic member (such as the blanket 15) may be integrally moved in a state in which the movable base 12 is fixed.

Further, in the above-described embodiment and the like, the case in which the second stage 20 is lowered and brought closer to the first stage 10 (the supporting base 14), but the first stage 10 may be lifted. Furthermore, contact between the elastic member and the opposing member may be caused by changing the height of the protrusion 12A, without lifting and lowering of the first stage 10 and/or the second stage 20.

In addition, although the case of performing the letterpress printing by using the printing apparatus 1 has been described in the modification 2, planographic printing or intaglio printing such as gravure printing may be performed using the printing apparatus 1.

Furthermore, in the above-described application example, the case where the organic layer 94 (the luminous layer) of the display unit 90 is formed using the printing apparatus 1 has been described. However, other part of the display unit 90, e.g. the flattening layer 91 or the device separating film 93, may be formed using the printing apparatus 1. In addition, when the semiconductor film 83 of the transistor 80 is configured using an organic semiconductor material, the semiconductor film 83 may be formed using the printing apparatus 1. Alternatively, wiring (for example, the signal lines 96A and the scanning lines 97A) of the pixel driving circuit 98 may be formed through use of ink using metal nanoparticles. It is also possible to form a resist by using the printing apparatus 1.

In addition, for example, the materials and thicknesses, or the film formation methods and film formation conditions described in the above-described embodiment and the like are illustrative and not limitative. Other materials and thicknesses, or other film formation methods and film formation conditions may be adopted.

Moreover, the printing method (the printing apparatus) of the technology is applicable to a method of manufacturing a display unit provided with any of various kinds of display devices, such as a display unit provided with any of inorganic EL devices, liquid crystal devices, electrophoretic display devices, and the like, other than a display unit with organic EL devices.

Furthermore, the technology encompasses any possible combination of some or all of the various embodiments described herein and incorporated herein.

It is possible to achieve at least the following configurations from the above-described example embodiments of the disclosure.

(1) A printing method, including:

providing an elastic member at a first stage and providing ink between the elastic member and an opposing member, the first stage having a protrusion on a surface thereof; and

causing contact between the elastic member and the opposing member with the ink interposed therebetween, by using the protrusion.

(2) The printing method according to (1), wherein the elastic member and the first stage are moved relatively to each other in an in-plane direction, to cause the protrusion to enter below the elastic member and thereby to change a position of the protrusion relative to the elastic member.
(3) The printing method according to (1) or (2), wherein a supporting member that fixes a position of the elastic member relative to the opposing member is provided between the first stage and the elastic member.
(4) The printing method according to (3), wherein the elastic member and the supporting member are fixed by vacuum adsorption.
(5) The printing method according to (3) or (4), wherein

a low friction layer is provided between the supporting member and the first stage, and

the first stage is moved while being in contact with the low friction layer.

(6) The printing method according to any one of (3) to (5), wherein the first stage, the supporting member, and the elastic member are attached to one another by vacuum adsorption.
(7) The printing method according to any one of (3) to (6), wherein a buffering member is provided between the elastic member and the supporting member.
(8) The printing method according to any one of (1) to (7), wherein the opposing member is fixed to a second stage that faces the first stage.
(9) The printing method according to any one of (1) to (8), wherein the protrusion protrudes in a shape of an arc or in an angular shape from the surface of the first stage.
(10) The printing method according to any one of (1) to (8), wherein the protrusion is configured using a roll.
(11) The printing method according to any one of (1) to (10), wherein the protrusion includes a plurality of protrusions.
(12) The printing method according to any one of (1) to (11), wherein time of the contact between the elastic member and the opposing member is controlled using a width of the protrusion.
(13) The printing method according to any one of (1) to (12), wherein

the elastic member is a plate,

the opposing member is a printed member, and

the plate provided with the ink is brought into contact with the printed member.

(14) The printing method according to any one of (1) to (12), wherein

the elastic member is a blanket,

the opposing member is an intaglio plate, and

after a depression section of the intaglio plate is filled with the ink, the ink is transferred from the intaglio plate to the blanket.

(15) The printing method according to any one of (1) to (12), wherein

the elastic member is a blanket,

the opposing member is a relief plate, and

after the ink is applied to the blanket, the ink being in contact with a projection section of the relief plate is selectively removed.

(16) The printing method according to any one of (1) to (12), wherein

the elastic member is a blanket,

the opposing member is a printed member, and

after the ink having a predetermined pattern is provided on the blanket, the ink is transferred from the blanket to the printed member.

(17) A printing apparatus, including:

a first stage having a protrusion on a surface thereof and supporting an elastic member;

a coating section providing ink between the elastic member and an opposing member; and

a control section configured to cause, by the protrusion, contact between the elastic member and the opposing member with the ink interposed therebetween.

The disclosure contains subject matter related to that disclosed in Japanese Priority Patent Application JP 2012-128061 filed in the Japan Patent Office on Jun. 5, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A printing method, comprising:
providing an elastic member at a first stage and providing ink between the elastic member and an opposing member, the first stage having a protrusion on a surface thereof; and
causing contact between the elastic member and the opposing member with the ink interposed therebetween, by using the protrusion.

2. The printing method according to claim 1, wherein the elastic member and the first stage are moved relatively to each other in an in-plane direction, to cause the protrusion to enter below the elastic member and thereby to change a position of the protrusion relative to the elastic member.

3. The printing method according to claim 2, wherein a supporting member that fixes a position of the elastic member relative to the opposing member is provided between the first stage and the elastic member.

4. The printing method according to claim 3, wherein the elastic member and the supporting member are fixed by vacuum adsorption.

5. The printing method according to claim 3, wherein
a low friction layer is provided between the supporting member and the first stage, and
the first stage is moved while being in contact with the low friction layer.

6. The printing method according to claim 4, wherein the first stage, the supporting member, and the elastic member are attached to one another by vacuum adsorption.

7. The printing method according to claim 3, wherein a buffering member is provided between the elastic member and the supporting member.

8. The printing method according to claim 1, wherein the opposing member is fixed to a second stage that faces the first stage.

9. The printing method according to claim 1, wherein the protrusion protrudes in a shape of an arc or in an angular shape from the surface of the first stage.

10. The printing method according to claim 1, wherein the protrusion is configured using a roll.

11. The printing method according to claim 1, wherein the protrusion includes a plurality of protrusions.

12. The printing method according to claim 1, wherein time of the contact between the elastic member and the opposing member is controlled using a width of the protrusion.

13. The printing method according to claim 1, wherein
the elastic member is a plate,
the opposing member is a printed member, and
the plate provided with the ink is brought into contact with the printed member.

14. The printing method according to claim 1, wherein
the elastic member is a blanket,
the opposing member is an intaglio plate, and
after a depression section of the intaglio plate is filled with the ink, the ink is transferred from the intaglio plate to the blanket.

15. The printing method according to claim 1, wherein
the elastic member is a blanket,
the opposing member is a relief plate, and
after the ink is applied to the blanket, the ink being in contact with a projection section of the relief plate is selectively removed.

16. The printing method according to claim 1, wherein
the elastic member is a blanket,
the opposing member is a printed member, and
after the ink having a predetermined pattern is provided on the blanket, the ink is transferred from the blanket to the printed member.

17. A printing apparatus, comprising:
a first stage having a protrusion on a surface thereof and supporting an elastic member;
a coating section providing ink between the elastic member and an opposing member; and
a control section configured to cause, by the protrusion, contact between the elastic member and the opposing member with the ink interposed therebetween.
